(19) United States
(12) Patent Application Publication
(10) Pub. No.: US 2014/0378712 A1
(43) Pub. Date: Dec. 25, 2014

(54) ALKANOLYSIS PROCESS

(71) Applicant: INVISTA North America S.a.r.l., Wilmington, DE (US)

(72) Inventors: Suri N. Dorai, Weston Lakes, TX (US); Clive Alexander Hamilton, Swainby (GB); Qun Sun, Wilmington, DE (US)

(73) Assignee: INVISTA North America S.a.r.l., Wilmington, DE (US)

(21) Appl. No.: 14/372,933

(22) PCT Filed: Jan. 25, 2013
(86) PCT No.: PCT/US2013/023055

§ 371 Date: Jul. 17, 2014

Related U.S. Application Data
(60) Provisional application No. 61/591,016, filed on Jan. 26, 2012.

(51) Int. Cl. C08G 65/00

(52) U.S. Cl. CPC C08G 65/00
USPC 568/617

(57) ABSTRACT

The present invention provides an improved process for converting a diester of polyether polyol, e.g., PTMEA, to the corresponding dihydroxy product, e.g., polytetramethylene ether glycol (PTMEG) continuously in a reaction zone, such as, for example, a reactive distillation system, for achieving virtually complete conversion of PTMEA to PTMEG, and recovery of PTMEG free of unreacted or unconverted PTMEA and alkanol ester by-product.

### CROSS REFERENCE TO RELATED APPLICATION

This application claims benefit of priority from U.S. Provisional Application No. 61/591,016, filed Jan. 26, 2012. This application hereby incorporates by reference Provisional Application No. 61/591,016 in its entirety.

### FIELD OF THE INVENTION

The present invention relates to an improved process for alkanolysis of polyether polyol esters to polyether polyols. More particularly, as a non-limiting example, the invention relates to the methanolysis of polytetramethylene ether diacetate to polytetramethylene ether glycol, e.g., by reactive distillation with a C₁ to C₄ alkanol, e.g., methanol, and catalyst having the formula (R¹)₄NOR², wherein R¹ is selected from the group consisting of methyl, ethyl and combinations thereof and R² is selected from the group consisting of hydrogen, methyl, and ethyl, e.g., tetramethyl ammonium hydroxide.

### BACKGROUND OF THE INVENTION

Polytetramethylene ether glycol (PTMEG) is well known for use as soft segments in polyurethanes and other elastomers. This homopolymer is a commodity in the chemical industry which is widely used to form segmented copolymers with poly-functional urethanes and polyesters. PTMEG imparts superior dynamic properties to polyurethane elastomers and fibers.

It is known that in the preparation of polyether polyols, generally and specifically the polymerization of tetrahydrofuran (THF) and/or THF with comonomers in which acetic acid and acetic anhydride are used, the intermediate products will contain acetate or other end groups which must be subsequently converted to the hydroxyl functionality prior to ultimate use. For example, U.S. Pat. No. 4,163,115 discloses the polymerization of THF and/or THF with comonomers to polytetramethylene ether diester using a fluorinated resin catalyst containing sulfonic acid groups, in which the molecular weight is regulated by addition of an acylium ion precursor to the reaction medium. The patent discloses the use of acetic anhydride and acetic acid in combination with the solid acid catalyst. The polymeric product is isolated by stripping off the unreacted THF and acetic acid/acetic anhydride for recycle. The isolated product is the diacetate of polymerized tetrahydrofuran (PTMEA) which must be converted to the corresponding dihydroxy product, polytetramethylene ether glycol (PTMEG), to find application as a raw material in most urethane end use applications. Consequently, the ester end-capped polytetramethylene ether is reacted with a basic catalyst and an alkanol such as methanol to provide the final product polytetramethylene ether glycol and methyl acetate as a by-product.

U.S. Pat. Nos. 4,230,892 and 4,584,414 disclose processes for the conversion of PTMEA to PTMEG comprising mixing a polytetramethylene ether diester with an alkanol of 1 to 4 carbons, and a catalyst which is an oxide, hydroxide, or alkoxide of an alkaline earth metal and an alkali metal hydroxide or alkoxide, respectively, bringing the mixture to its boiling point and holding it there while the vapors of the alkanol/alkyl ester azeotrope which form are continuously removed from the reaction zone, until conversion is essentially complete; and then removing the catalyst. Using CaO at 50° C. showed incomplete conversions when methanolysis was carried out in four staged continuously stirred reactors. Also, high catalyst levels were necessary, and the process was not energy efficient because of the high heat input required to vaporize methanol in the four staged reactors. Further, the finished product PTMEG contained small amounts of unreacted PTMEA, which is not a desirable component in urethane reactions.

U.S. Pat. No. 5,852,218 discloses reactive distillation wherein a diester of polyether polyol, e.g., PTMEA, is fed to the top portion of the distillation column along with an effective amount of at least one alkali metal oxide or alkaline earth metal oxide, hydroxide or alkoxide catalyst (e.g., sodium methoxide) and with a C₁ to C₄ alkanol (e.g., methanol) while simultaneously adding to the bottom of the reactive distillation column hot alkanol vapor to sweep any alkanol ester formed by alkanolysis of the diester of polyether polyol upwardly. This process is useful for achieving high levels of conversion PTMEA to PTMEG on a commercial scale with the overhead from the distillation column being amenable to azeotropic separation of the methyl acetate and recycle of the alkanol, e.g., methanol.

None of the above publications teach alkanolysis of polyether polyol esters to polyether polyols using reactive distillation with catalyst having the formula (R¹)₄NOR², wherein R¹ is selected from the group consisting of methyl, ethyl and combinations thereof and R² is selected from the group consisting of hydrogen, methyl, and ethyl, e.g., tetramethyl ammonium hydroxide (TMAH). More particularly, none of the above publications teach methanolysis of polytetramethylene ether diacetate to polytetramethylene ether glycol by reactive distillation with methanol and tetramethyl ammonium hydroxide, an important embodiment of the present invention.

### SUMMARY OF THE INVENTION

The present invention provides an improved process for converting a diester of polyether polyol, e.g., PTMEA, to the corresponding dihydroxy product, e.g., polytetramethylene ether glycol (PTMEG). The present invention provides an improved process for achieving virtually complete conversion and recovery of PTMEG free of unreacted or unconverted PTMEA and alkanol ester by-product.

An embodiment of the present invention comprises a process for converting the diester of a polyether polyol to a corresponding dihydroxy polyether polyol comprising steps of:
(1) contacting the diester of a polyether polyol and a C₁ to C₄ alkanol, e.g., methanol, with a catalyst having the formula (R¹)₄NOR², wherein R¹ and R² are the same or different, and wherein R¹ is independently selected from the group consisting of methyl, and ethyl, and R² is selected from the group consisting of hydrogen, methyl, and ethyl, e.g., tetramethyl ammonium hydroxide, in a reaction zone to convert at least a portion, for example 80% by weight or more, of the diester to the dihydroxy polyether polyol,
(2) recovering reaction zone effluent from step (1) comprising the dihydroxy polyether polyol and catalyst from the reaction zone, said effluent comprising, for example, less than about 1% by weight of alkanol ester formed by alkanolysis, (3) thermally treating the recovered reaction zone effluent from step (2) at a temperature sufficient to convert at least a portion of the catalyst to a trialkylamine having a boiling point lower than the boiling point of the dihydroxy polyether polyol, and
(4) flashing the thermally treated reaction zone effluent of step (3) to produce a stream comprising trialkylamine and a stream comprising dihydroxy polyether polyol.

The thermal treatment step (3) may be carried out at a temperature of for example from about 100 to about 200° C., from 120 to 180° C., from 130 to 170° C., or at about 140° C.±10° C.

Another embodiment of the present invention comprises converting the diester of a polyether polyol to a corresponding dihydroxy polyether polyol comprising the steps of:
(a) feeding to the upper portion of a distillation column at least one diester of polyether polyol, an effective amount of catalyst having the formula (R¹)₄NOR², wherein R¹ and R² are the same or different, and wherein R¹ is selected from the group consisting of methyl, ethyl and combinations thereof and R² is selected from the group consisting of hydrogen, methyl, and ethyl, e.g., tetramethyl ammonium hydroxide, and a C₁ to C₄ alkanol to convert the diester of polyether polyol to dihydroxy polyether polyol;
(b) adding to the lower portion of the distillation column hot C₁ to C₄ alkanol vapor to sweep any alkanol ester formed by alkanolysis of the diester of polyether polyol upwardly in the distillation column;
(c) recovering an overhead stream from the distillation column comprising alkanol and alkanol ester formed by alkanolysis; and
(d) recovering a bottom stream from the distillation column comprising dihydroxy polyether polyol essentially free of alkanol ester formed by alkanolysis.

In one embodiment of the present invention the overhead from the distillation column is subjected to further separation and recovery of unreacted alkanol from the alkanol ester; and the alkanol produced in the separation is recycled to the distillation column. In one embodiment of the invention the diester of polyether polyol is the diacetate ester of polytetramethylene ether, PTMEA, and the alkanol is methanol, thus recovering polytetramethylene ether glycol, PTMEG, free of methyl acetate. In this embodiment according to the present invention the overhead from the reactive distillation column, containing unreacted methanol and the methyl acetate ester by-product, is further subjected to azeotropic separation of the methyl acetate and subsequent recycle of the methanol having less than 500 ppm, for example, less than 100 ppm, methyl acetate to the distillation column.

The invention includes an improved process for the alkanolysis of polyether polyol esters to produce polyether polyol, for example using reactive distillation, such as to drive the reaction to completion. Technical benefits of the invention can include substantially complete separation of by-product alkanol ester from polyether polyol, thus producing product dihydroxy polyether polyol of high purity. The invention can include subsequent separation of the overhead stream from a reactive distillation column such as to provide for recycle of the alkanol. Fulfillment of these features and the presence and fulfillment of additional features will become apparent upon complete reading of the specification including claims and attached drawing.

### DETAILED DESCRIPTION OF THE INVENTION

As a result of intense research in view of the above, we have discovered an improved process whereby we can manufacture a dihydroxy polyether polyol, e.g., polytetramethylene ether glycol (PTMEG), from the diester of polyether polyol, e.g., PTMEA, continuously in a reaction zone, such as, for example, a reactive distillation system, for achieving virtually complete conversion of the diester of polyether polyol to dihydroxy polyether polyol, and recovery of dihydroxy polyether polyol free of unreacted or unconverted diester of polyether polyol and alkanol ester by-product. Other diesters of polyether glycols are also suitable for use in this invention, such as the diesters of polytetraethylene ether glycol and diesters of polytetrapropylene ether glycol, merely to name two examples.

The term “polymerization”, as used herein, unless otherwise indicated, includes the term “copolymerization” within its meaning.

The term “PTMEG”, as used herein, unless otherwise indicated, means polytetramethylene ether glycol. PTMEG is also known as polyoxybutylene glycol.

The term “THF”, as used herein, unless otherwise indicated, means tetrahydrofuran and includes within its meaning alkyl substituted tetrahydrofuran capable of copolymerizing with THF, for example 2-methyltetrahydrofuran, 3-methyltetrahydrofuran, and 3-ethyltetrahydrofuran.

The term “alkylene oxide”, as used herein, unless otherwise indicated, means a compound containing two, three or four carbon atoms in its alkylene oxide ring. The alkylene oxide can be unsubstituted or substituted with, for example, linear or branched alkyl of 1 to 6 carbon atoms, or aryl which is unsubstituted or substituted by alkyl and/or alkoxy of 1 or 2 carbon atoms, or halogen atoms such as chlorine or fluorine. Examples of such compounds include ethylene oxide (EO); 1,2-propylene oxide; 1,3-propylene oxide; 1,2-butylene oxide; 1,3-butylene oxide; 2,3-butylene oxide; styrene oxide; 2,2-bis-chloromethyl-1,3-propylene oxide; epichlorohydrin; perfluoroalkyl oxiranes, for example (1H,1H-perfluoropentyl) oxirane; and combinations thereof.

The THF referred to herein can be any of those commercially available. Typically, the THF has a water content of less than about 0.03% by weight and a peroxide content of less than about 0.005% by weight. If the THF contains unsaturated compounds, their concentration should be such that they do not have a detrimental effect on the polymerization process or the polymerization product thereof. Optionally, the THF can contain an oxidation inhibitor such as butylated hydroxytoluene (BHT) to prevent formation of undesirable byproducts and color. If desired, one or more alkyl substituted THF's capable of copolymerizing with THF can be used as a co-reactant, in an amount from about 0.1 to about 70% by weight of the THF. Examples of such alkyl substituted THF's include 2-methyltetrahydrofuran, 3-methyltetrahydrofuran, and 3-ethyltetrahydrofuran.

The alkylene oxide referred to herein can have a water content of less than about 0.03% by weight, a total aldehyde content of less than about 0.01% by weight, and an acidity (as acetic acid) of less than about 0.002% by weight. The alkylene oxide can be low in color and non-volatile residue.

If, for example, the alkylene oxide reactant is EO, it can be any of those commercially available. Suitably, the EO has a water content of less than about 0.03% by weight, a total aldehyde content of less than about 0.01% by weight, and an acidity (as acetic acid) of less than about 0.002% by weight. The EO should be low in color and non-volatile residue.

THF can be polymerized using solid acid resin catalyst and acetic acid/acetic anhydride as molecular weight moderators as described in U.S. Pat. No. 4,163,115, incorporated herein by reference. Typically the THF conversion to polymer ranges from about 20 to 40% at temperature of about 40° C. to 50° C. The polymeric product can be isolated by stripping off the unreacted THF and acetic acid/acetic anhydride for recycle. The product so isolated is the polymerized diacetate of tetrahydrofuran (PTMEA), which must be converted to the dihydroxy product polytetramethylene ether glycol (PTMEG) to find application as a raw material in most urethane end use applications.

The polyether polyol diester composition used herein is generally any polyether such as polyether typically produced via an acid catalyzed ring opening polymerization reaction of a cyclic ether or mixture in the presence of a carboxylic acid and carboxylic acid anhydride wherein tetrahydrofuran is the major and/or dominant reactant; i.e., substantial THF being incorporated into the PTMEA product. More specifically, the polyether diester is derived from the polymerization of tetrahydrofuran (THF) with or without an alkyl substituted tetrahydrofuran comonomer, for example 3-methyl tetrahydrofuran (3-MeTHF), as well as the copolymerization of THF (again with or without 3-MeTHF) and with an alkylene oxide such as ethylene oxide or propylene oxide or equivalent comonomer. As such, the following description and examples will predominantly refer to THF with the understanding that the other comonomers may optionally be present.

Typically the products of the initial polymerization process are in the form of acetates (or similar terminal ester groups) which are converted to the hydroxyl group terminated glycols by reacting them with methanol in the presence of transesterification/alkanolysis catalysts. This reaction requires a catalyst to attain reasonable rates. Common methanolysis catalysts useful for this purpose include sodium methoxide (NaOMe), sodium hydroxide (NaOH), and calcium oxide. In principle the catalyst useful for such a reaction is a highly alkaline alkanolysis catalyst generally categorized as an alkali metal or alkaline earth metal oxide, hydroxide or alkoxide catalyst and mixtures thereof as taught in U.S. Pat. Nos. 4,230,892 and 4,584,414 (here incorporated by reference for such purpose). Commonly used are alkanolysis catalysts that inherently have some water scavenging capability without loss of catalyst activity (e.g., NaOH/NaOMe/Na₂O system wherein trace water is converted to the catalytically active NaOH). The reaction rate using NaOH/NaOMe is rapid even at room temperature and therefore methanolysis is carried out at atmospheric pressures. The by-product in this methanolysis is methyl acetate which forms a lower boiling azeotrope with methanol. The alkanolysis reaction is reversible and therefore continuous removal of volatile methyl acetate/methanol azeotrope is essential to obtain a commercially reasonable conversion rate. In the process of U.S. Pat. No. 5,852,218, this is done in a reactive distillation column wherein methanol vapor is fed into the column bottom to strip the polymer of methyl acetate. By stripping methyl acetate in this manner, high conversion of PTMEA to PTMEG, for example greater than 99%, is achieved in the column. In contrast to the reactive distillation process at least five sequential continuously stirred reactor stages are required to achieve complete conversion.

Although the process of U.S. Pat. No. 5,852,218 has been commercially used for conversion of PTMEA to PTMEG, the catalyst used therein, i.e., a highly alkaline catalyst generally categorized as an alkali metal or alkaline earth metal oxide, hydroxide or alkoxide, presents problems such as the need for neutralisation with, for example magnesium sulphate, to form insoluble salts which must be removed by expensive and operationally intense filtration steps. For example, the alkali metal or alkaline earth metal oxide, hydroxide or alkoxide catalyst, e.g., NaOMe, may be removed as described in U.S. Pat. No. 5,410,093, the teachings of which are herein incorporated by reference.

The catalyst for use in the present improved process has the formula (R¹)₄NOR², wherein R¹ and R² are the same or different, and wherein each R¹ is independently selected from the group consisting of methyl, and ethyl, and R² is selected from the group consisting of hydrogen, methyl, and ethyl. Examples of the catalyst for use herein include tetramethyl ammonium hydroxide, trimethyl ethyl ammonium hydroxide, dimethyl diethyl ammonium hydroxide, methyl triethyl ammonium hydroxide, tetraethyl ammonium hydroxide, tetramethyl ammonium methoxide, trimethyl ethyl ammonium methoxide, dimethyl diethyl ammonium methoxide, methyl triethyl ammonium methoxide, tetraethyl ammonium methoxide, tetramethyl ammonium ethoxide, trimethyl ethyl ammonium ethoxide, dimethyl diethyl ammonium ethoxide, methyl triethyl ammonium ethoxide and tetraethyl ammonium ethoxide.

An embodiment of the catalyst for use in the present improved process is tetramethyl ammonium hydroxide (TMAH or TMAOH) which is a quaternary ammonium salt with the molecular formula (CH₃)₄NOH. Problems associated with use of alkali metal or alkaline earth metal oxide, hydroxide or alkoxide catalysts are avoided in the present process. Without wishing to be bound by any particular theory of operation, it has been found that tetramethyl ammonium hydroxide catalyst used in the present invention is easily removed from a product stream by heating and distillation without adversely affecting the conversion, or quality of the product. As an example, TMAH easily decomposes at a temperature of from about 120° C. or higher, for example from 120° C. to 135° C., to methanol and trimethylamine which are easily removed by distillation. Thus a technical effect observed in one embodiment of the invention is the elimination of mixing, precipitation and filtering steps used with other catalysts such as sodium methoxide.

The catalyst, for example TMAH, is present in the alkanolysis step of the present invention in a catalytically effective amount, which in the usual case means a concentration of from about 100 ppm to about 1000 ppm by weight of the reaction mixture, for example from about 400 ppm to about 800 ppm, such as from about 500 ppm to about 700 ppm, as the penthydrate complex.

The alkanolysis step of the present invention is generally carried out at from about 50° C. to about 100° C., such as from about 65° C. to about 90° C., for example from about 75° C. to about 85° C. In the reactive distillation system, the pressure is ordinarily atmospheric pressure, but reduced or elevated pressure may be used to aid in controlling the temperature of the reaction mixture during the reaction. For example, the pressure employed may be from about 5 to about 100 psig, (about 259 to about 5171 mmHg), for example from about 20 to about 80 psig (about 1034 to about 4137 mmHg), for example about 30 to about 60 psig (about 1551 to about 3102 mmHg).

The number average molecular weight of the PTMEG product of this invention, determined by end group analysis using spectroscopic methods well known in the art, can be as high as about 30,000 dalton, but will usually range from 650 to about 5000 dalton, and more commonly will range from about 650 to 3000 dalton.

In the present process, essentially complete conversion of polyether polyol diester, e.g., PTMEA, to dihydroxy polyether polyol, e.g., PTMEG, is achieved in a single reactive distillation column using counter-current flow. The term “essentially complete conversion” means at least 98%, such as from 98% to 100%, for example 98.1% or higher, conversion of PTMEA to PTMEG. As a non-limiting example, when employing methanol as the alcohol reactant in the alkanolysis reaction, a reactive distillation column operating at 65° C. to 70° C. and 0 to 5 psig has been found to be a cost-effective and energy-efficient method of achieving essentially complete conversion of PTMEA to good quality PTMEG.

The present process can be carried out in any suitable reactor, such as a continuous stirred tank reactor (CSTR), a batch reactor, a tubular concurrent reactor or any combination of one or more reactor configurations known to those skilled in this art. If using reactive distillation, a single distillation column can be employed in a continuous manner. This reactive distillation can be performed by any of the distillation process and equipment as generally known and practiced in the art. For example but not by way of limitation, a deep seal sieve tray distillation column can be used. A conventional tray distillation column is similarly suitable.

In view of the description of specific embodiments, it should be appreciated that the reactive distillation column can be considered for purposes of this invention as involving stripping as a necessary feature (in contrast to rectification). In other words, the ascending hot alkanol vapor reactant introduced at or near the bottom of the distillation column and the consequential reactive stripping of the alkanol ester formed in the alkanolysis/transesterification reaction is a paramount consideration in achieving the desired essentially total conversion of polyether polyol to the corresponding dihydroxy polyether polyol. For all practical purposes the recovery of purified distillate and hence the concept of reflux and/or rectification can be performed advantageously in a separate column (e.g., witness the use of the separate azeotropic distillation in the case of methyl acetate formation). Of course this does not mean that the distillation and recovery of purified distillate overhead in a single column cannot be employed but rather the instant invention affords the opportunity to separate the reactive stripping from the recovery and recycle of unreacted alcohol. In fact, this also affords the opportunity to achieve separation and recovery of the overhead stream components by techniques other than distillation.

Mathematical modeling indicates that the methyl acetate concentration in the hot methanol stream fed to the bottom of the reactive distillation column should be less than 100 ppm in order to achieve a high conversion, for example 99.999%, in the reactive distillation column. Control of the methyl acetate concentration in the bottom methanol stream of the azeotrope column to a level less than 500 ppm, for example, a level less than 100 ppm, has been achieved. The azeotrope distillation column bottom should be operated at a temperature greater than 66° C. to ensure a methyl acetate concentration of less than 100 ppm. A higher concentration of methyl acetate tends to have an adverse effect on the conversion of PTMEA to PTMEG in the reactive distillation column.

The alkanolysis process in a reactive distillation column according to the present invention is robust and results in essentially complete conversion of PTMEA to PTMEG. The amount of catalyst required for the present continuous process is about 200 to 1000 ppm based on PTMEA, for example 500 to 700 ppm. Similar amounts fail to produce comparable yields in a batch process.

The amount of make-up methanol needed during continuous operation with methanol recycle (both azeotropic recovery of overhead and stripping from PTMEG product) is in principle equal to the stoichiometric amount of PTMEA in the feed to the reactive distillation column (i.e., two moles of methanol consumed for each mole of PTMEG formed) plus a corresponding amount consumed in the distillation of the (85%) methyl acetate azeotrope creating part of the recycle methanol (i.e., the amount of free methanol in the co-product azeotrope). Commercially available methanol feed to be used as make-up to the reactive distillation column typically has less than 500 ppm water, and may contain less than 200 ppm. This small amount of water is not detrimental to the process. However, a large amount of water in the system is extremely detrimental as water slowly hydrolyzes PTMEA to produce PTMEG and free acetic acid. Acetic acid produced in this manner neutralizes the catalyst and this can drive the conversion to less than 50%.

Typically, about 50 to 120 ppm free acetic acid in the PTMEA feed will not adversely affect the methanolysis. The presence of unpolymerized THF in PTMEA has virtually no effect on operability of this process or product quality. Free THF ends up in the overheads of the reactive distillation column. No build-up of THF is indicated during continuous operation of this process.

By way of illustration, a specific embodiment of the process is performed in a reactive distillation column by feeding the polyether polyol ester, substantially free of unpolymerized THF and acetic anhydride/acetic acid (ACAN/HOAc), to or near the top of the column. The methanolysis catalyst (for example, a solution of TMAH dissolved in MeOH) is also fed to the reactive distillation column, either mixed with the polyether polyol ester (PTMEA) prior to entering the column, or at a point near the feed point for the polyether polyol ester. Vaporized methanol (hot MeOH) is fed near bottom of the reactive distillation column so that it contacts the unreacted PTMEA containing the least amount of free acetic acid in the presence of TMAH catalyst to drive the equilibrium to complete conversion. The overhead from the column is a mixture of methanol and methyl acetate. This overhead may be routed to an azeotrope distillation column to azeotropically recover the methanol. PTMEG and MeOH are drawn off the column bottom. The excess MeOH may be removed in a methanol stripper operating under at a reduced pressure between about 100 and 450 mm Hg, and at a temperature of about 125 to 145° C. The resulting PTMEG stream is then essentially free of MeOH, and contains unreacted transesterification catalyst, i.e., TMAH. The TMAH is suitably removed as described in U.S. Pat. No. 5,410,093, the teaching of which is incorporated herein by reference.

In this specific embodiment, the methyl acetate concentration in the hot methanol stream fed to the bottom of the reactive distillation column may be controlled at less than 100 ppm in order to achieve a high conversion, e.g., 99.999%, in the reactive distillation column. The azeotrope distillation column bottom can be operated at temperatures greater than 66° C. for a methyl acetate concentration of less than 100 ppm.

The following Examples demonstrate the present invention and its capability for use. The invention is capable of other and different embodiments, and its several details are capable of modifications in various apparent respects, without departing from the spirit and scope of the present invention. Accordingly, the Examples are to be regarded as illustrative in nature and non-limiting.

### EXAMPLES

PTMEA methanolysis was carried out in glassware, at atmospheric pressure, by means of fractionation using a Vigreux™ column. The reaction was followed by collecting samples of the vapor phase distillate in an ethylene glycol diacetate diluent using Gas Chromatography (GC). Examples 1 and 2 employed common methanolysis catalysts sodium methoxide (NaOMe) and sodium hydroxide (NaOH), respectively, for the methanolysis process. Examples 3 and 4 employed tetramethylammonium hydroxide (TMAH.5H₂O) to demonstrate the improvement realized by the present process.

### Example 1

In a Vigreux™ column, a 0.033 gram of NaOMe was added to 100 grams of PTMEA along with 64 grams of methanol. The resulting mixture thus contained 200 ppm of NaOMe with a 20:1 methanol to PTMEA molar ratio based on an assumed PTMEA molecular weight of 1000 g/mol. The solution was heated in an oil bath to its normal boiling point (˜66° C.) whereupon the transesterification reaction product, methyl acetate (MeOAc), and excess methanol vapor passed up the Vigreux™ column and condensed in the receiving vessel. The receiving vessel contained 100 grams of ethylene glycol diacetate as diluent. Samples were extracted from the receiving vessel as a function of time and analyzed by GC. The experiment was run until the weight percent MeOAc in the receiving vessel reached a peak (after ˜60 minutes). The resulting liquid phase sample (PTMEG) was analyzed for conversion by NMR and found to be 98.5% converted

### Example 2

Example 1 was repeated except with 0.039 gram of NaOH rather than 0.033 gram of NaOMe added to 100 grams of the PTMEA along with 64 grams of methanol. The resulting mixture thus contained 240 ppm of NaOH with a 20:1 methanol to PTMEA molar ratio. The reaction again took ˜60 minutes to complete and the resulting liquid phase sample (PTMEG) was analyzed for conversion by NMR and found to be 96.5% converted.

### Example 3

Example 1 was repeated except with 0.22 gram of TMAH.5H₂O rather than 0.033 gram of NaOMe added to 200 grams of the PTMEA along with 128 grams of methanol. The resulting mixture thus contained 650 ppm of TMAH.5H₂O with a 20:1 methanol to PTMEA molar ratio. The final liquid phase sample (PTMEG), following recovery and use of a rotary evaporator to thermally treat reaction effluent and flash the thermally treated effluent, was analyzed for conversion by NMR and found to be 98.6% converted. The sample was methyl acetate free with virtually no PTMEA residue.

### Example 4

In a Vigreux™ column, a 0.11 gram quantity of TMAH.5H₂O was added to 100 grams of the PTMEA along with 64 grams of methanol. The resulting mixture contained 650 ppm of TMAH.5H₂O with a 20:1 methanol to PTMEA molar ratio. As in Example 3, the solution was heated in the oil bath to its normal boiling point (˜66° C.) whereupon methyl acetate (MeOAc) and methanol vapor passed up to the Vigreux™ column and condensed in the receiving vessel which contained 100 grams of ethylene glycol diacetate. Samples were extracted from the receiving vessel as a function of time and analyzed by GC. The experiment was run until the weight percent MeOAc in the receiving vessel reached a peak (˜60 minutes). At this stage the oil bath was removed, the reaction mixture cooled and a further 64 grams of methanol was added. The oil bath was reapplied and the solution heated for a further 60 minutes. The process of further methanol addition was repeated five more times. The oil bath was finally removed and the resulting liquid phase sample was heated in a rotary evaporator to ˜140° C. for 60 minutes at 100 mBara, followed by a further 24 hours at <1 mBara. The resulting liquid phase sample (PTMEG) was analyzed for conversion by NMR and found to be 99.8% converted, pH neutral, 0.9 ppm elemental nitrogen by chemiluminescence (below the instrument threshold) of excellent color and odorless. The sample was methyl acetate free with virtually no PTMEA residue.

Advantages and benefits of the improved process according to the present invention are significant. For example, relative to the historical use of methanolysis to convert PTMEA to PTMEG, with or without use of reactive distillation, the improved process of the present invention produces a methyl acetate free product stream with virtually no PTMEA residue and at essentially complete conversion to PTMEG, i.e., 98.6 and 99.8%. The present invention further offers an advantage in terms of economy of using a single stage or distillation column to achieve essentially total conversion with savings in terms of both capital and energy requirements. Further, the present invention provides an advantage in terms of treatment of the bottom stream of a reactive distillation column for isolation of the product PTMEG. The instant process also exhibits an advantage in providing for reuse of methanol containing less than 100 ppm methyl acetate and thus ensures virtually total conversion at the bottom of a reactive distillation column.

While the illustrative embodiments of the invention have been described with particularity, it will be understood that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present invention, including all features which would be treated as equivalents thereof by those skilled in the art to which the invention pertains.

What is claimed is:

1. A process for converting the diester of a polyether polyol to a corresponding dihydroxy polyether polyol comprising steps of:
(1) contacting the diester of a polyether polyol and a C₁ to C₄ alkanol with catalyst having the formula (R¹)₄NOR², wherein R¹ and R² are the same or different, and wherein each R¹ is independently selected from the group consisting of methyl, ethyl and combinations thereof, and R² is selected from the group consisting of hydrogen, methyl, and ethyl, in a reaction zone to convert at least a portion of the diester to the dihydroxy polyether polyol,
(2) recovering reaction zone effluent from step (1) comprising the dihydroxy polyether polyol and catalyst from the reaction zone,
(3) thermally treating the recovered reaction zone effluent from step (2) at a temperature sufficient to convert at least a portion of the catalyst to a trialkylamine having a boiling point lower than the boiling point of the dihydroxy polyether polyol, and
(4) flashing the thermally treated reaction zone effluent of step (3) to produce a stream comprising trialkylamine and a stream comprising dihydroxy polyether polyol.

2. The process of claim 1 wherein the reaction zone comprises a distillation column and step (4) comprises flashing the thermally treated reactor effluent of step (3) to produce an overhead stream comprising trialkylamine and a bottom stream comprising dihydroxy polyether polyol.

3. The process of claim 1 wherein the alkanol is methanol, the catalyst is tetramethyl ammonium hydroxide and at least 80% by weight of the diester of polyether polyol is converted to the corresponding dihydroxy polyether polyol.

4. The process of claim 3 wherein the reaction zone effluent from step (1) recovered in step (2) comprises less than about 1% by weight of alkanol ester formed by alkanolysis.

5. The process of claim 1 wherein the temperature sufficient to convert at least a portion of the catalyst to a trialkylamine having a boiling point lower than the boiling point of the dihydroxy polyether polyol in step (3) is from about 100 to about 200° C.

6. The process of claim 2 wherein the C₁ to C₄ alkanol enters the reaction zone as a vapor at a temperature above ambient.

7. The process of claim 6 wherein the C₁ to C₄ alkanol enters the reaction zone as a superheated vapor.

8. The process of claim 6 wherein the C₁ to C₄ alkanol vapor flows upwardly to remove at least a portion of any alkanol ester formed by alkanolysis from the reaction zone.

9. The process of claim 7 wherein the superheated C₁ to C₄ alkanol vapor flows upwardly to remove at least a portion of any alkanol ester formed by alkanolysis from the reaction zone.

10. The process of claim 2 further comprising steps of:
(1) separating the overhead stream to recover unreacted alkanol, and (2) recycling the recovered alkanol from step (5) to the reaction zone.

11. The process of claim 3 wherein the diester of polyether polyol is the diacetate ester of polytetramethylene ether.

12. A process for converting the diester of a polyether polyol to a corresponding dihydroxy polyether polyol comprising the steps of:
(a) feeding to the upper portion of a distillation column at least one diester of polyether polyol, an effective amount of catalyst having the formula (R¹)₄NOR², wherein R¹ and R² are the same or different, and wherein R¹ is selected from the group consisting of methyl, ethyl and combinations thereof and R² is selected from the group consisting of hydrogen, methyl, and ethyl, and a C₁ to C₄ alkanol to convert the diester of polyether polyol to dihydroxy polyether polyol;
(b) adding to the lower portion of the distillation column hot C₁ to C₄ alkanol vapor to sweep any alkanol ester formed by alkanolysis of the diester of polyether polyol upwardly in the distillation column;
(c) recovering an overhead stream from the distillation column comprising alkanol and alkanol ester formed by alkanolysis; and
(d) recovering a bottom stream from the distillation column comprising dihydroxy polyether polyol essentially free of alkanol ester formed by alkanolysis.

13. The process of claim 12 wherein the diester of polyether polyol is the diacetate ester of polytetramethylene ether, the alkanol is methanol, the catalyst is tetramethyl ammonium hydroxide, and the recovered bottom stream comprises polytetramethylene ether glycol.

14. The process of claim 12 further comprising steps of:
(a) separating the overhead stream to recover alkanol, and
(b) recycling the recovered alkanol from step (e) to the distillation column.
